(19) United States
(12) Patent Application Publication
(10) Pub. No.: US 2011/0105128 A1
(43) Pub. Date: May 5, 2011

(54) SYSTEM INFORMATION MANAGEMENT IN WIRELESS COMMUNICATION SYSTEMS

(75) Inventor: Murali Narasimha, Lake Zurich, IL (US)

(73) Assignee: Motorola Mobility, Inc., Libertyville, IL (US)

(21) Appl. No.: 12/912,102

(22) Filed: Oct. 26, 2010

Related U.S. Application Data
(60) Provisional application No. 61/257,801, filed on Nov. 3, 2009.

(51) Int. Cl. H04W 36/00; H04W 24/02

(52) U.S. Cl. 455/442; 455/424

(57) ABSTRACT

A method in a wireless communication entity includes storing system information of a first base station when it is within coverage of the first base station and attached to a second base station, determining that the mobile station is no longer within the coverage of the first base station subsequent to storing the system information of the first base station, and deleting the stored system information of the first base station.

### CROSS REFERENCE TO RELATED APPLICATIONS

The present application is a non-provisional application of U.S. provisional application No. 61/257,801 filed on 3 Nov. 2009, the contents of which are incorporated by reference herein and from which benefits are claimed under 35 U.S.C. 119.

### FIELD OF THE DISCLOSURE

The present disclosure relates to wireless communications and, more particularly, to managing system information in wireless communication devices and wireless communication networks.

### BACKGROUND

In order to be able to perform handover from a macro base station to a home base station in a wireless communication system, a mobile station must acquire system information of such cells when still connected to the macro base station. A home base station may also be referred to as a Closed Subscriber Group (CSG) cell, a hybrid cell, a femto cell, a home Node-B (HNB), a home eNode-B (HeNB), among others depending on the context. The acquisition of system information (SI) is required for at least two reasons.

System Information (SI) is required to resolve Physical Cell Identifier (PCID) confusion. More particularly, a serving cell may not be able to uniquely identify a home cell based on its PCID. Thus the mobile station needs to acquire SI to obtain a unique identifier of the home cell (cell global identifier). This information is then reported to the serving cell.

System Information (SI) is also required to check accessibility of the cell. If the home cell is a Closed Subscriber Group (CSG) cell, the mobile station is allowed to handover to it only if the mobile station is a member of the CSG. The mobile station must acquire SI to obtain the CSG indication (to check whether a cell is a CSG cell) and the CSG identifier to check whether the mobile station is a member.

Acquired System Information (SI) is only useful while the mobile station is near the home cell and a handover to the home cell is potentially possible. Given the small coverage area of home cells, there can be many home cells within the coverage area of a macro cell. Consequently, there is a high likelihood that there are multiple home cells using the same Physical Cell Identifier (PCID).

It is important to promptly mark acquired System Information (SI) as not valid (or delete it) when the UE is clearly outside the range of the home cell. If the SI is not promptly marked as invalid, there is a risk of using incorrect Si when the mobile station encounters another cell with the same PCID as the one for which it previously acquired SI. Since the mobile station reports SI to the network, the network also needs to promptly delete the reported SI when the mobile station is clearly outside the range of the home cell.

A system Information (SI) validity time limit can be imposed so that the mobile station deletes the acquired SI after a specified time period. The main problem with this approach is to find a suitable value for the timer. A short value of the timer would require SI re-acquisition of the same cell repeatedly, especially for mobile stations that are not mobile. If a long value of the timer is used, the mobile station can not re-acquire SI when the mobile station sees another cell with the same PCID, since it has a valid SI corresponding to that PCID. This can result in the mobile station reporting incorrect SI if network asks the mobile station to report SI, and mobile station not reporting SI when it should, because it previously reported SI corresponding to the PCID. Furthermore, in order to correctly delete the SI at the eNB, the eNB would have to run a timer each time any UE reports SI.

Therefore there is a need for a method for ensuring correct deletion of stored SI. It should be noted that “Deleting of out-dated SI” and “Marking SI as invalid” are considered equivalent for the purpose of this disclosure.

The various aspects, features and advantages of the disclosure will become more fully apparent to those with ordinary skill in the art on consideration of the following Detailed Description and the accompanying drawings. The drawings have been simplified for clarity and are not necessarily drawn to scale.

### BRIEF DESCRIPTION OF THE DRAWINGS

FIG. 1 is a schematic diagram illustrating the need for promptly deleting out-dated SI or marking out-dated SI as invalid.

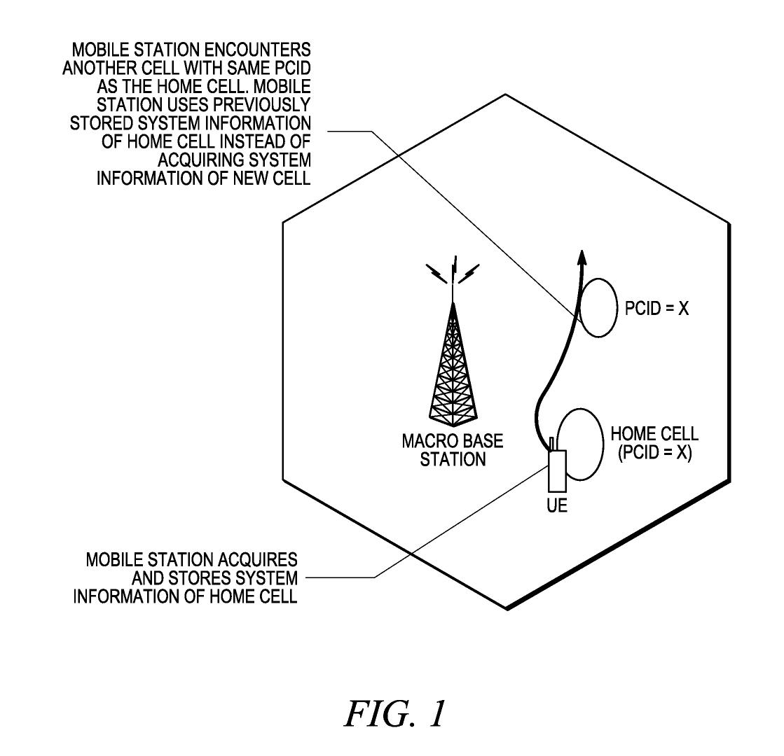

FIG. 2 is a schematic diagram illustrating a first embodiment.

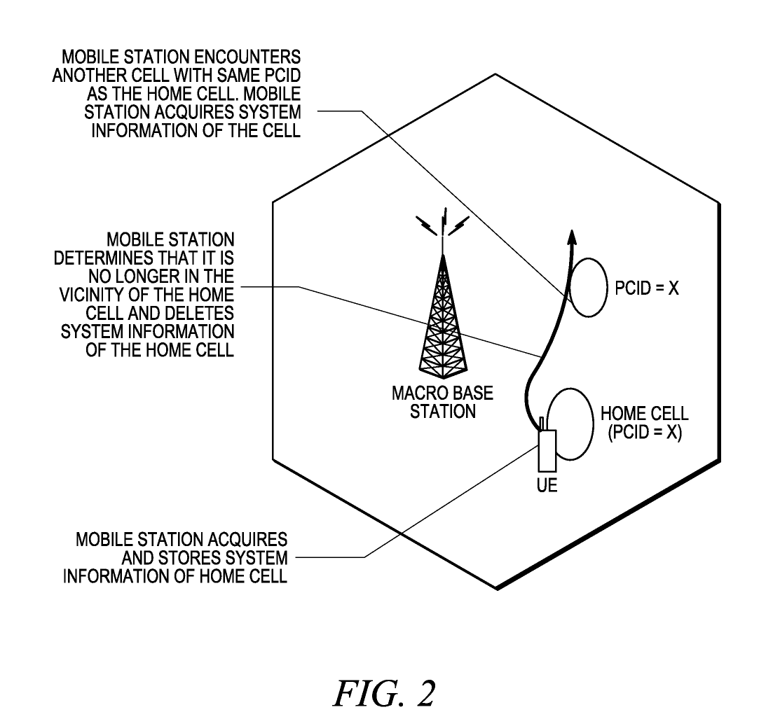

FIG. 3 is a schematic diagram illustrating a second embodiment.

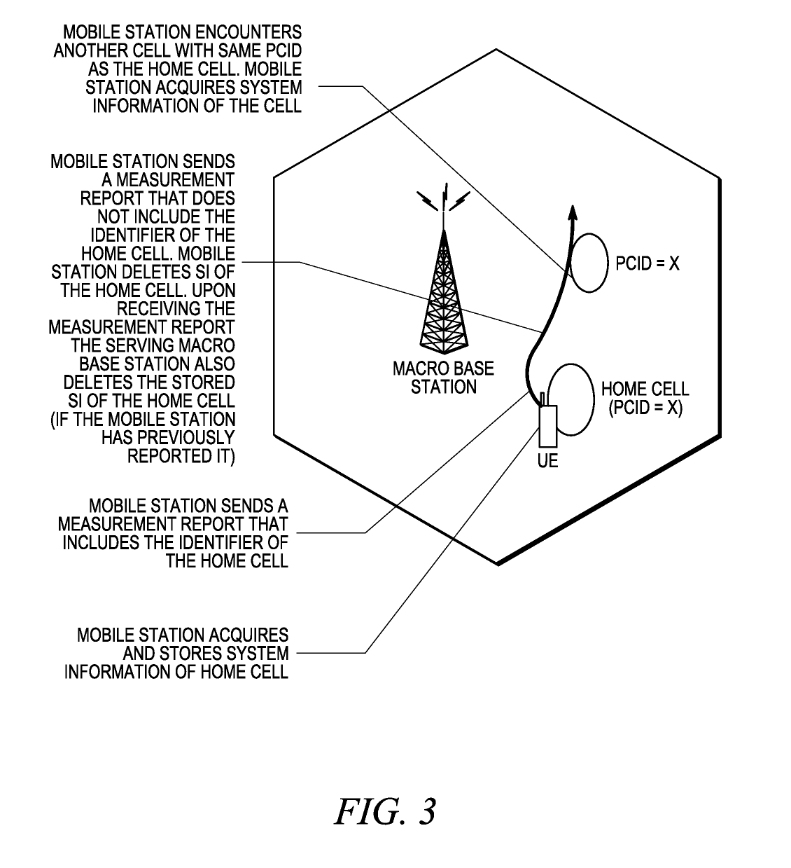

### DETAILED DESCRIPTION

According to a first embodiment, the mobile station first acquires System Information (SI) from a home cell when it is in the vicinity of the home cell. The mobile station can report at least some of the SI to the network. The mobile station can then continuously or periodically determine whether it is in the vicinity of the home cell from which it acquired the SI. The determination of whether it is in the vicinity of the cell can be done using location based techniques such as GPS or radio environment fingerprinting. Radio environment fingerprinting consists of associating a location with a set of base station signals visible at the location. Upon determining that it is no longer in the vicinity of the home cell, the mobile station can delete the SI acquired from the home cell. The mobile station can also indicate to the network that it is no longer in the vicinity of the home cell. This enables the network to delete the SI of the home cell previously reported by the mobile station.

One problem with the method of the first embodiment is that the accuracy with which the mobile station can determine whether it is no longer in the vicinity of the home cell may not be adequate. With insufficient accuracy, the SI of the home cell may be prematurely deleted and may have to be acquired again. This causes unnecessary and repeated re-acquisition of SI of the home cell. Alternatively, the mobile station may conservatively estimate its location to avoid premature deletion of SI. This can cause the stored SI to be used (incorrectly) when the mobile station encounters another cell with the same PCID as the home cell. A second embodiment is provided that overcomes the problems of the first embodiment.

According to the second embodiment, the mobile station acquires SI from a home cell when it is within the coverage area of the home cell and further subject to some constraints specified by the network. The mobile station can report at least some of the SI of the home cell to the network. Subsequent to acquisition of the SI from the home cell, the mobile station can send measurement reports to the network that include one or more cells of which the mobile station is able to measure the signal conditions. Specifically, a measurement report can include an identifier of one or more cells and a measured signal condition parameter value corresponding to each identifier included. The identifier can be the PCID of the cell.

The network may specify criteria regarding which cells should be included in the measurement report. For example, the network can specify that the n strongest cells must be included in the measurement report. The mobile station can determine whether the SI of the home cell should be deleted based on whether the measurement reports include the identifier of the home cell. For example, if the network specifies that the measurement report should include the n strongest cells, if the home cell is not one of the n strongest cells, it is not included in the measurement report. Consequently the mobile station can delete the SI of the home cell. When the serving base station receives a measurement report that does not include the home cell, if the mobile station has previously reported the SI of the home cell to the serving base station, then the serving base station can delete the SI of the home cell. In other words, the absence of the home cell from a measurement report can be used as an indication at both the mobile station and the serving base station that the mobile station is no longer in the vicinity of the home cell and the SI of the home cell can be deleted.

According to another example, suppose that the network specifies that the measurement report should include the n strongest cells. The mobile station can decide to delete the SI of the home cell if m consecutive measurement reports do not include the identifier of the home cell.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the invention, which is to be limited not by the exemplary embodiments but by the appended claims.

What is claimed is:

1. A method in a wireless communication entity, the method comprising:
storing, at the wireless communication entity, system information of a first base station when a mobile station is within coverage of the first base station and attached to a second base station;
subsequent to storing the system information of the first base station, determining that the mobile station is no longer within the coverage of the first base station; and
deleting the stored system information of the first base station.

2. The method according to claim 1 wherein the first base station is selected from a group comprising: a femto cell, a pico cell, a home base station, a closed subscriber group cell, and a hybrid cell.

3. The method according to claim 1 wherein deleting the stored system information of the first base station includes marking the stored system information of the first base station as invalid.

4. The method according to claim 1 wherein storing system information of the first base station when the mobile station is within the coverage of the first base station comprises
detecting, at a mobile station, the presence of the first base station, and
acquiring, at the mobile station, system information from the first base station and storing the acquired system information.

5. The method according to claim 1 wherein determining that the mobile station is no longer within the coverage of the first base station comprises determining that a current geographical location of the mobile station is substantially different from a geographical location of the mobile station when the mobile station was in the coverage of the first base station.

6. The method according to claim 5 wherein determining that the current geographical location of the mobile station is substantially different from the geographical location of the mobile station when the mobile station was in the coverage of the first base station includes determining that a radio signal fingerprint corresponding to the current location of the mobile station is substantially different from a radio signal fingerprint corresponding to the location of the mobile station when the mobile station was in the coverage of the first base station.

7. The method according to claim 6 wherein the radio signal fingerprint at a location includes at least a subset of signals received from a plurality of base stations at the location.

8. The method according to claim 1 wherein storing system information of the first base station when the mobile station is within the coverage of the first base station comprises receiving and storing, at the second base station, system information of the first base station.

9. The method according to claim 8 wherein receiving and storing, at the second base station, system information of the first base station, includes
receiving, at the second base station, from the mobile station, system information of the first base station, and
storing, at the second base station, the system information of the first base station.

10. The method according to claim 8 wherein receiving and storing, at a second base station, system information of the first base station, includes
receiving, at the second base station, from the mobile station, an indication that the mobile station has detected the first base station, and
transmitting from the second base station to the first base station, a request for transmission of the system information of the first base station, and
receiving, at the second base station, the system information of the first base station and storing, at the second base station, the received system information.

11. The method according to claim 1 wherein determining that the mobile station is no longer within the coverage of the first base station comprises receiving, at the second base station, an indication that the mobile station is not within the coverage of the first base station.

12. The method according to claim 1 further comprising
receiving, at the mobile station, a parameter indicating a maximum number of cells to include in a measurement report,
wherein determining that the mobile station is no longer within the coverage of the first base station includes determining that a measurement report does not include an identifier of the first base station.

13. The method according to claim 12 wherein determining that a measurement report does not include an identifier of the first base station includes
ranking, at the mobile station, a plurality of cells based on signal quality criteria, and
determining, at the mobile station, that the first base station is absent from a highest n cells according to the ranking, the parameter n being equal to the maximum number of cells to include in a measurement report.

14. The method according to claim 1 further comprising
receiving, at the second base station from the mobile station, a first measurement report including an identity of the first base station,
wherein determining that the mobile station is no longer within the coverage of the first base station includes receiving at the second base station, subsequent to receiving the first measurement report, a second measurement report not including the identity of the first base station.

15. A method in a wireless communication entity, the method comprising:
storing system information of a first base station when a mobile station is within coverage of the first base station;
subsequent to storing the system information of the first base station, ranking a plurality of cells based on signal quality criteria;
determining, according to the ranking, that the first base station is ranked lower than a threshold rank; and
deleting the stored system information of the first base station in response to determining that the first base station is ranked lower than the threshold rank.

16. The method according to claim 15 wherein storing system information of a first base station when a mobile station is within the coverage of the first base station includes
receiving, at a second base station, from the mobile station, system information of the first base station when the mobile station is within the coverage of the first base station, and
storing, at the second base station, the received system information of the first base station.

17. The method according to claim 15 wherein determining that the first base station is ranked lower than the threshold rank includes performing, at the second base station, the following:
receiving from the mobile station a measurement report,
ranking base stations reported in the measurement report, and
determining that the first base station is ranked lower than the threshold rank.

18. The method according to claim 15 further comprising performing, at the mobile station, the following:
receiving the threshold rank parameter,
performing measurements of base stations and ranking the base station measurements based on signal quality criteria, and
transmitting a measurement report including only the measured base stations that are ranked higher than the threshold rank.

19. The method according to claim 15 wherein the threshold rank is a maximum number of cells that can be included in a measurement report, and wherein determining that the first base station is ranked lower than a threshold rank includes determining that the first base station is not included in a measurement report.

20. A wireless communication device comprising:
a transceiver,
a controller coupled to the transceiver,
the controller configured to perform measurements of base station signals,
the controller configured to determine a threshold rank and to rank measured base station signals based on signal quality criteria, and
the controller configured to cause the transceiver to transmit a measurement report including identifiers of only measured base station that are ranked higher than the threshold rank.
